(19) United States
(12) Patent Application Publication
(10) Pub. No.: US 2017/0312777 A1
(43) Pub. Date: Nov. 2, 2017

(54) CART SPRAYER

(71) Applicant: CHAPIN MANUFACTURING, INC., Batavia, NY (US)

(72) Inventor: JAMES R. FONTAINE, MARILLA, NY (US)

(21) Appl. No.: 15/582,455

(22) Filed: Apr. 28, 2017

Related U.S. Application Data
(60) Provisional application No. 62/329,817, filed on Apr. 29, 2016.

(51) Int. Cl. B05B 15/08; B05B 9/00; B05B 9/04; B05B 12/00

(52) U.S. Cl. CPC B05B 15/08; B05B 12/002; B05B 9/007; B05B 9/0423

(57) ABSTRACT

A walk from behind, also called a push or cart sprayer having an assembly of wheeled frame and a tank. The frame has a rearward extending handle which enables the assembly to be pushed along a path. The tank has a connected boom assembly including a pivotal boom arm along the front of the tank with a distal spray nozzle, and a mechanism enabling the boom arm to be pivoted to the sides of the tank where the nozzle sprays away from the path, to the side of the path, so that possible toxic or corrosive spraying liquid cannot be stepped upon by the operator pushing the sprayer, thereby enhancing safety of operation. The boom arm is also pivotal to the front of the tank, such as useful when the cart sprayer is towed.

Priority is claimed to U.S. Provisional Patent Application Ser. No. 62/329,817, filed Apr. 29, 2016, which is herein incorporated by reference.

### FIELD OF THE INVENTION

The present invention relates to cart sprayers, and particularly to push from behind cart sprayers, sometimes called push, cart sprayers. The cart sprayer of the present invention is especially useful to control the location of sprayed liquid along the ground with respect to the path of travel of the sprayer using a multi-positional movable boom disposed along the front of the sprayer.

### BACKGROUND OF THE INVENTION

Cart sprayers often spray corrosive and/or toxic liquids which can present a safety hazard. This hazard confronts operators of cart sprayers on the market, as for example from Master Manufacturing of Paynesville, Minn., Fimco Industries of North Sioux City, S. Dak., TurfEx Products of Madison Heights, Mich. and Earthway Products Inc. of Bristol, Ind. Such cart sprayers have fixed nozzles mounted on the carts thereof, especially to their tanks and at the front of the tanks. Therefore spray is dispensed ahead of the sprayer over the ground where the sprayer travels and through which the operator must walk while pushing the sprayer from behind.

### SUMMARY OF THE INVENTION

Accordingly, it is a principal object of the invention to provide an improved cart sprayer which can be pushed from behind without endangering the safety of the operator by requiring the operator to push the sprayer and walk on freshly sprayed areas of the ground just sprayed upon.

It is an object of the invention to provide an improved cart sprayer having a boom arm rotationally mounted along the front of the sprayer to extend away from the sprayer, which can be selectably rotated to the left of right side of the path of travel of the cart sprayer to apply pumped liquid via a nozzle disposed at the distal end of the boom arm along the left or right side, respectively, of such path of travel.

Another object of the invention is to provide an integrated assembly of tank, frame and electrical and hydraulic components in an improved cart sprayer.

It is another object of the invention to provide an improved cart sprayer having a frame with a saddle supporting the tank of the sprayer in the center of the tank, and with wheels on the frame, and also with a push from behind handle on a shaft carried by the frame.

The present invention provides an improved cart sprayer where the ground spraying nozzle is moveable to a position away from the path over which the sprayer travels to a selected position out of that path. This position is next to said path, preferably to a side thereof. A boom assembly is provided for moving the nozzle to the selected position having an arm which carries the nozzle near or at the outward distant end of the arm. The arm is rotatably mounted in a mounting of the boom assembly attached to the cart sprayer, preferably at the front of the tank thereof, and hence may be referred to herein as a boom arm. The arm is rotated by the operator to bring the nozzle to its selected position. A mechanism in the boom assembly releasably locks the boom arm at the selected position. The selected position of the boom arm may be one of two positions on opposite sides of the spray cart, each 180° of the rotation of the arm, apart from each other. Accordingly, neither the cart sprayer, nor the operator walking behind the sprayer, travels upon freshly sprayed ground just sprayed upon, thereby avoiding being exposed to the danger of toxic or corrosive spraying liquid. Optionally, the cart sprayer may be towed, and the selected position of the boom arm moved to the front of the sprayer cart 90° of rotation of the arm from selected side positions.

To rotationally mount the boom arm, the cart sprayer has a bracket having a slot mounted along the front of sprayer's tank, a pin (or pivot member) extends through a central hole of the bracket via the slot, and the boom arm has a proximal end with an opening through which such pin extends to rotationally mount the boom arm for motion about such pin along the slot of the bracket. The pin defines the axis of rotation for the boom arm along the slot of the bracket to move the nozzle disposed at the distal end of the boom arm about an approximate 180° rotation around the front of the tank.

To minimize risk of damage to the boom arm during storage or transportation of the cart sprayer, another opening is provided at least approximately centered about a length of the boom arm, and the pin is repositioned to extend through the bracket's central hole and this another opening of the boom arm via the slot of the bracket, so as to minimize rotational motion of the arm and to reduce the extent the boom arm extends distally from the sprayer.

The mechanism for releasably locking the boom arm may have detents along one of the walls defining the slot of the bracket for engaging a spring biased member of the boom arm when the boom arm is pivoted to each of its pivot positions. Preferably, such mechanism for releasably locking the boom arm is provided by a plurality of holes in the bracket that extend into the slot of the bracket, where each hole is associated with a different one of the boom arm's pivot positions, and a retainer member, such as a pin, being received in one of such plurality of holes to engage the boom arm so as to lock the boom arm from pivoting. Removal of the retainer member enables selection of another hole in the bracket associated with a different one of the pivot positions to receive the retainer member for engagement with the boom arm.

The invention also provides a cart sprayer having an integrated assembly of a frame and a tank. The frame may have a U-shaped saddle section which fits into a recess between upper and lower sections of the tank. Downwardly extending legs of the saddle section hold bearings for a shaft, and at the ends of the shaft wheels of the cart are rotationally mounted. These legs are attached to the tank on a flat back side thereof opposite a front side which is curved, and such front side has the recess for containing the U-shaped part of the saddle section. A back section of the frame has side legs which are attached to the legs of the saddle section of the frame. The downward ends of these side legs can provide feet for resting the cart sprayer on the ground. The upper part of the side legs merge together into an upwardly tilted position along a shaft which is attached to handles for pushing the cart sprayer from behind.

The cart sprayer has an electro-hydraulic system with the components thereof mounted on the inside and on the outside of a plate. This plate is attached to the back of the tank over a recess or space in the tank wall for containing the components which are mounted on the inside of the plate. The outside of the tank has a receptacle for a removable and replaceable battery (preferably of the rechargeable lithium-ion type). The battery powers an electric motor driven demand pump mounted on the inside of the plate. Also mounted on the inside of the plate is an electrical switch responsive to the output pressure of the pump for cutting off power from the battery to the pump drive motor when the pressure exceeds a certain pressure (for example, 50 psi).

A spray wand with a shut-off may be connected to the pump output via a two-way valve mounted on the inside of the plate with a control handle or lever on the outside of the plate. The spray wand has a trigger controlling such shut-off so that the operator can enable or disable flow of pumped liquid to the spray head which is mounted at the end of the wand's tubular shaft. The liquid from the tank may be pumped by the pump via the two-way valve to select either spraying with the wand, or the nozzle on the boom arm.

When the wand is selected by the control handle of the two-way valve and spraying is stopped by the shut-off on the wand, the increase in output pressure from the pump is sensed by the pressure responsive switch and electric current to the pump motor is disconnected, all automatically. This integrated electrical hydraulic and mechanical assembly of spray liquid tank, a wheeled frame, and electrical and hydraulic components on the inside and outside of a mounting plate, provides an improved multi-function (boom nozzle and wand) cart sprayer system.

### BRIEF DESCRIPTION OF THE DRAWINGS

The foregoing and other objects and advantages of the invention will become more apparent from a reading of the following detailed description with the accompanying drawings wherein:

FIG. 1 is a side view of a cart sprayer embodying the invention, the view being taken from the right side of the sprayer;

FIG. 2 is a top view of the cart sprayer of FIG. 1 with a boom arm carrying a ground spraying nozzle positioned along the path of travel of the sprayer, especially for tow-from-behind operation with the ground spraying nozzle;

FIG. 3 is a top view similar to FIG. 2, but with the boom arm pivoted to another position bringing the ground spraying nozzle to a right side of the path of travel of the sprayer;

FIG. 4 is a top view similar to FIGS. 2 and 3, but with the boom arm in another position than shown in FIGS. 2 and 3, namely to bring the ground spraying nozzle of the boom arm to a left side of the travel path of the sprayer;

FIG. 4A is a perspective view of the cart sprayer of FIG. 1 taken from the front thereof in which the boom arm is positioned as shown in FIG. 4;

FIG. 4B is a side view of the cart sprayer of FIG. 1 taken from the right side thereof in which the boom arm is positioned as shown in FIG. 4;

FIG. 5 is a front view of the cart sprayer of FIG. 1;

FIG. 5A is another front view of the cart sprayer of FIG. 1 in which the boom arm is positioned as shown in FIG. 4 and spray is illustrated from the nozzle of the boom arm;

FIG. 6A is a rear or back view of the cart sprayer of FIG. 1 in which the boom arm is positioned as shown in FIG. 4;

FIG. 6B is a bottom view of the cart sprayer of FIG. 1 in which the boom arm is positioned as shown in FIG. 4;

FIG. 7 is a view of the cart sprayer of FIG. 1 taken from the front with the tank removed showing the front side of a panel of the cart sprayer;

FIG. 7A is a broken view of the cart sprayer of FIG. 1 taken from the rear with the back panel removed showing the pump and hoses coupled thereto as shown in FIG. 6A having the tank outlet port to the pump inlet provided by a T-shaped conduit with an opening providing a drain;

FIG. 7B is a broken cross-sectional view of the T-shaped conduit of FIG. 7A in which the opening providing the drain is closed by a cap;

FIGS. 8A and 8B are two exploded perspective views of the cart sprayer of FIG. 1 taken from the front and rear, respectively;

FIG. 9 is a schematic diagram of the parts of the hydraulic circuit of the cart sprayer of FIG. 1 mounted on the plate of FIG. 7 attached to the back of the tank of the cart sprayer;

FIG. 10 is a schematic diagram of the electric circuit of the cart sprayer of FIG. 1 which is mounted on the plate attached to the back of the tank;

FIG. 11 is a perspective view of the cart sprayer of FIG. 1 having an exploded view of the boom arm mechanism for positioning the ground spray nozzle selectively at any one of the positions of the boom arm shown in FIG. 2, 3 or 4;

FIG. 11A is a partial view of FIG. 11 to show the exploded view of the assembly of the boom arm mechanism in more detail;

FIG. 12A is a cross-sectional view taken along line 12A-12A of FIG. 1 in the direction of arrows at the end of such line showing part of a mechanism for releasably locking the boom arm of FIG. 1 at each of its pivot positions depicted in FIGS. 2, 3, and 4, respectively;

FIG. 12B is a partial cross-sectional view taken along line 12B-12B of FIG. 2 in the direction of arrows at the end of such line of the mechanism for releasably locking the boom arm of FIG. 1 when locked at one of the positions associated with FIG. 2;

FIG. 13 is a partial view from the front of the cart sprayer of FIG. 1 in which the boom arm of FIG. 1 is disposed in an alternative position for storage or transportation of the cart sprayer;

FIG. 14 is a broken view of FIG. 4A showing another mechanism for releasably locking the boom arm of FIG. 1 that may be used for locking the boom arm at each of its pivot positions, rather than the mechanism shown in FIGS. 12A and 12B; and

FIG. 15 is a partial cross-sectional view taken along line 15-15 of FIG. 3 in the direction of arrows at the end of such line of the boom arm, but with the mechanism of FIG. 14 for releasably locking the boom arm of FIG. 1.

### DETAILED DESCRIPTION OF THE INVENTION

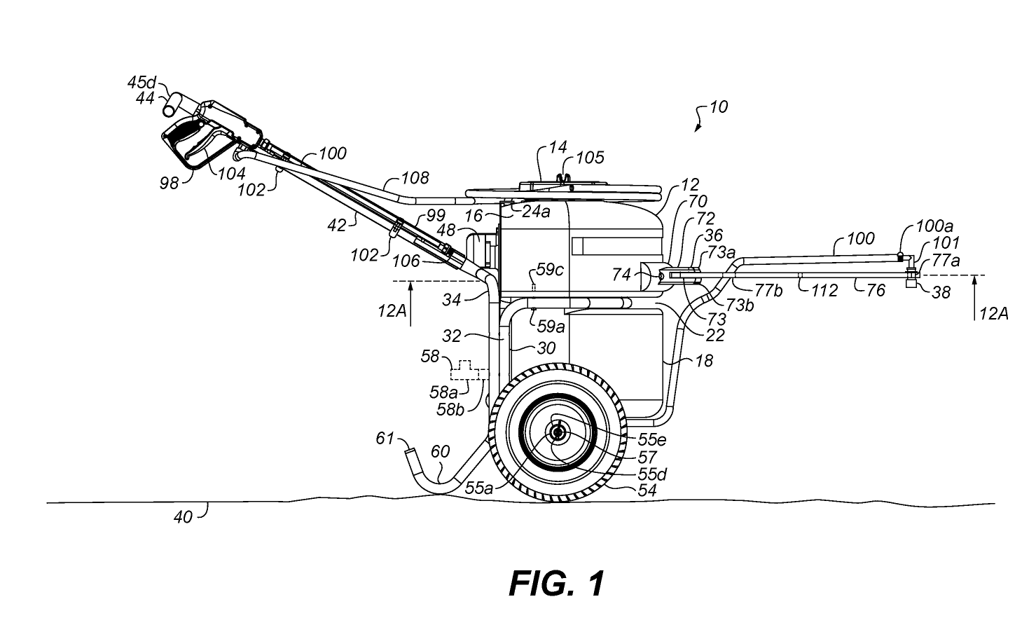

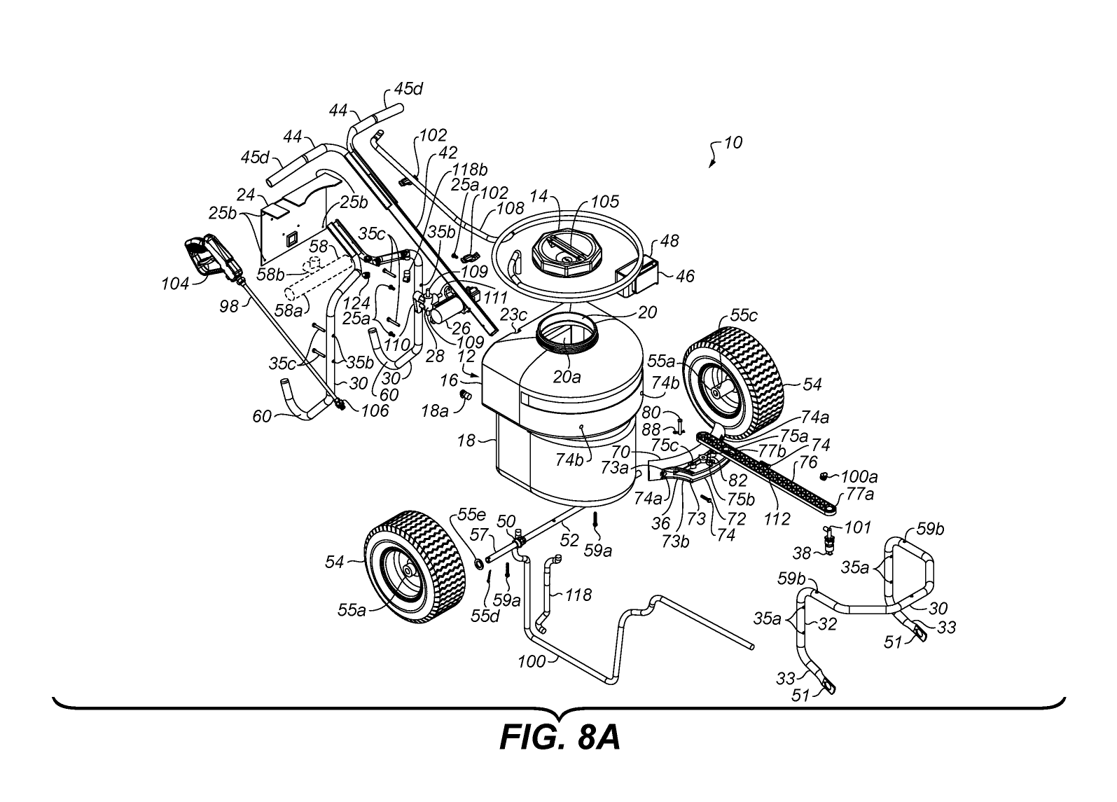

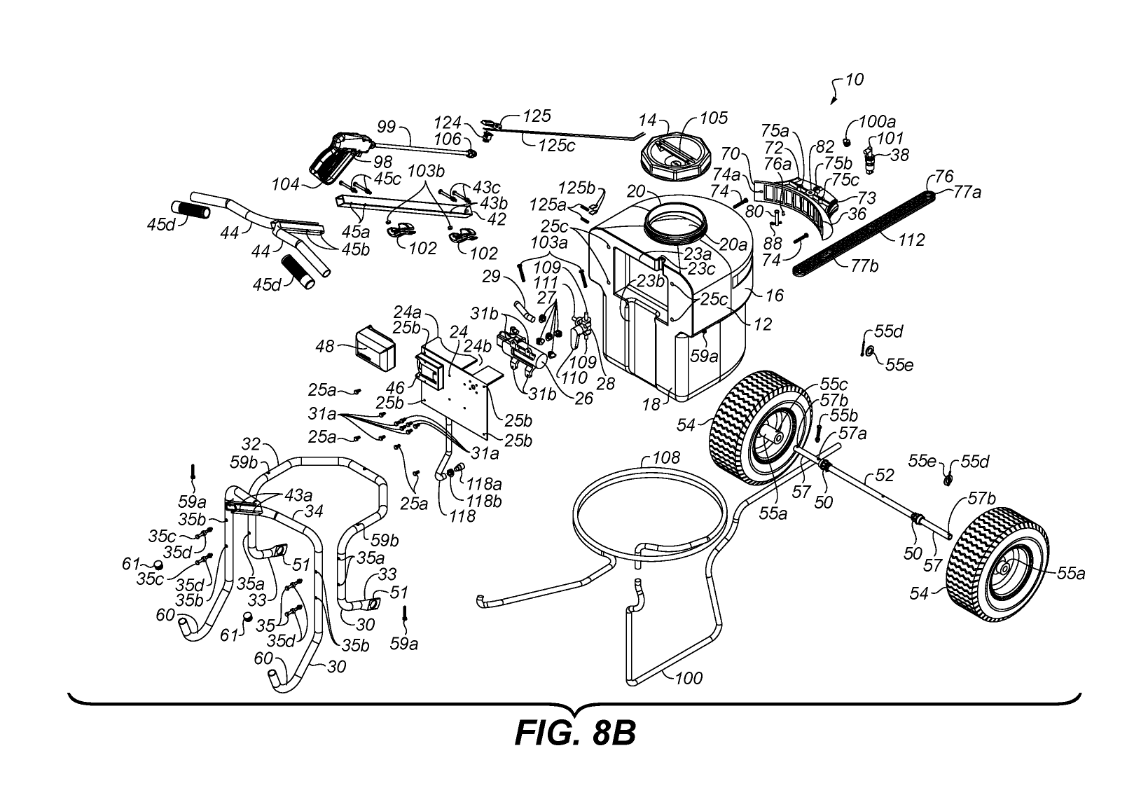

Referring to FIGS. 1, 2, 3, 4, 4A, 4B, 5, 5A, 6A, and 6B, a cart sprayer 10 having a tank (or housing) 12 for carrying spraying liquid (or fluid) is shown, such sprayer 10 being shown as an exploded assembly in FIGS. 8A and 8B. A filling cap 14 is provided to the top or crown of tank 12 via a threaded collar 20 (FIGS. 8A and 8B) about an opening 20a in the center of the crown of the tank. Tank 12 has upper and lower tank sections 16 and 18, respectively, spaced from each other to define a recess 22. Such recess 22 being best shown in FIGS. 1, 5, and 8A. The front of tank sections 16 and 18 are generally hemi-cylindrical, while the back of the tank sections 16 and 18 are flat, but for recesses 23a and 23b, and channel 23c (FIG. 8B). Tank 12 may be of injection blow molded plastic material.

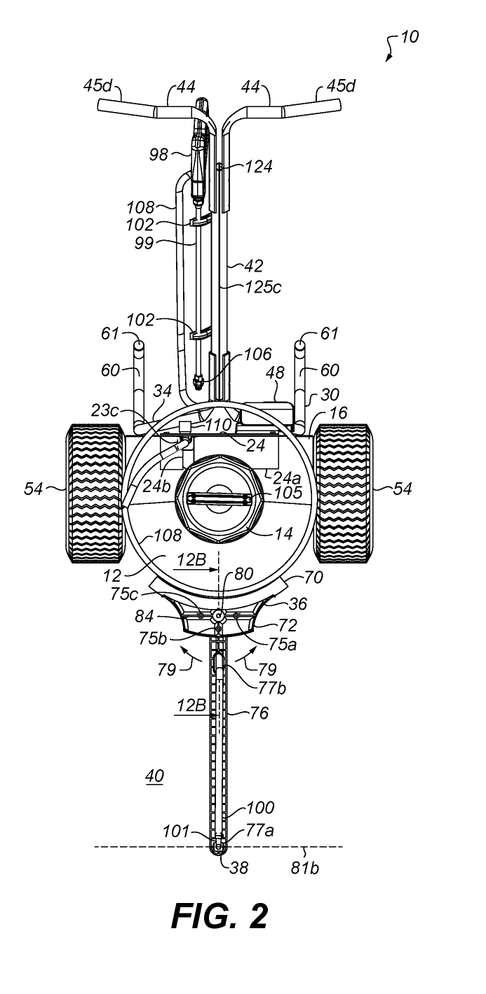

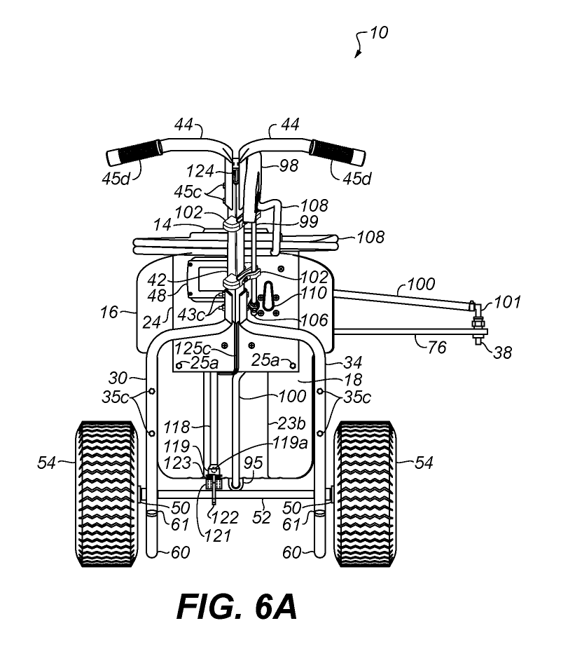

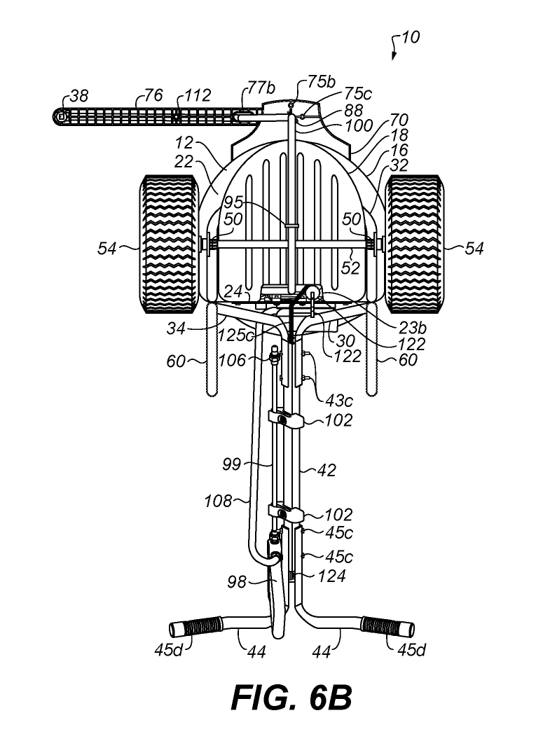

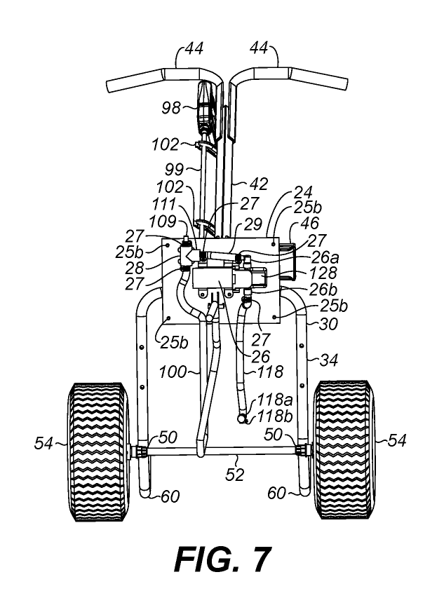

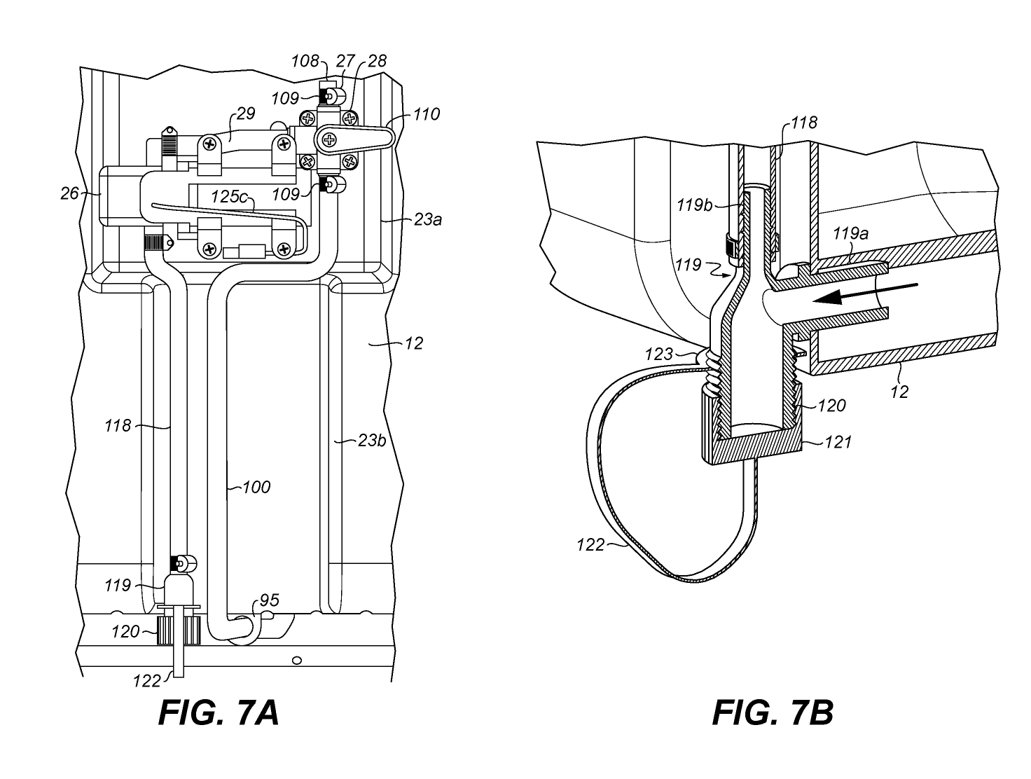

The recess 23a along the back of the top tank section 16 accommodates pump hydraulic components, such as a two-way valve 28 and a pump 26, which are disposed along the interior side or surface of a plate 24 as best shown in FIG. 7 with the tank 12 removed. Pump 26 is preferably a demand pump with an electric motor, such as available, for example, from Precision Spray Equipment, a Division of Green Leaf, Inc. of Fontanet, Ind., U.S.A., but other electrically powered pump units may be used. Plate 24 is attached to the back of top tank section 16 by four bolts or screws 25a, via holes 25b, into threaded holes 25c molded along tank 12 (FIGS. 6A, 7, and 8B). Plate 24 is preferably L-shaped in which a top part 24a of the plate extend partially along the top of tank 12, and the rest of plate 24 extends perpendicular to part 24a along the back of tank 12. Depending on the extent the L-shaped part 24a of plate 12 extends along the top of tank 12, a portion of part 24a may be curved to accommodate collar 20a of tank 12 such as shown in FIGS. 2-4.

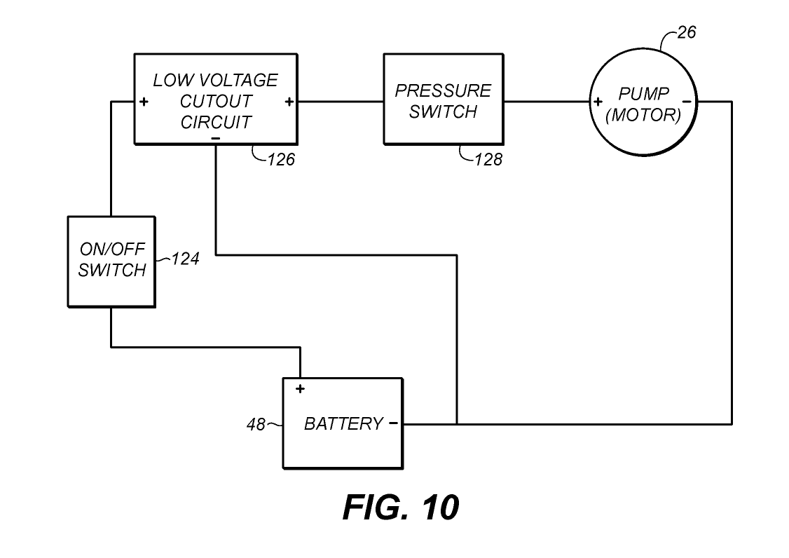

Electrical components may be disposed on the exposed, side, or exterior surface of plate 24 as shown in FIG. 6A. These electronic components include, for example, a shoe shaped connector (or receptacle) 46 (FIG. 8B) which is mounted on the back of plate 24 to releasably hold a battery 48, preferably of the rechargeable Lithium-ion type, for powering the electric motor of the pump 26. The battery 48 can be removed and replaced in the shoe connector 46. An ON-OFF switch 124 is also provided to enable and disable power to the motor or pump 26. The electrical components will be described later in more detail in connection with FIG. 10.

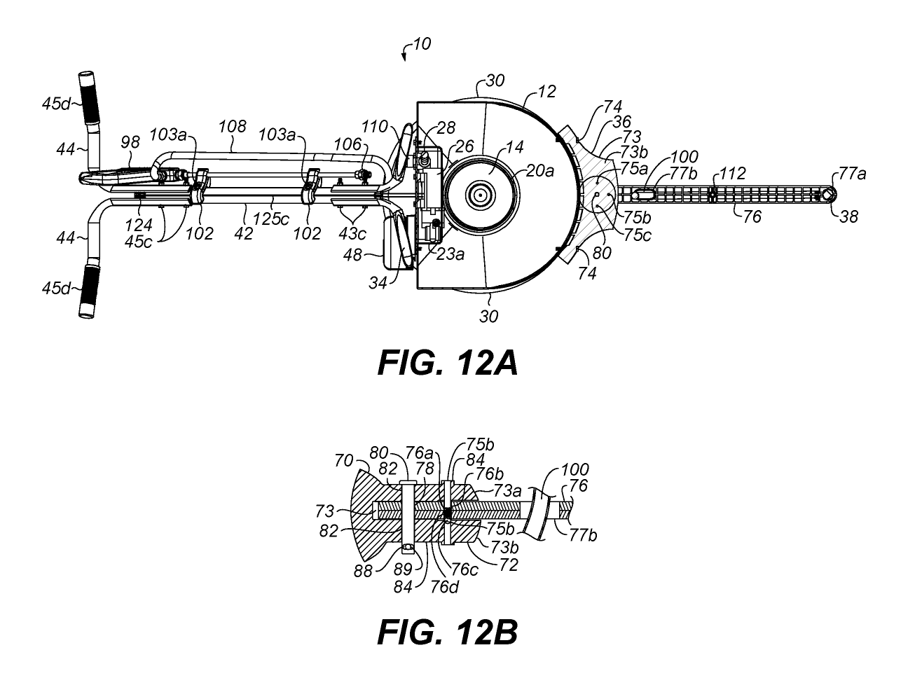

The tank 12 is in an assembly with a frame 30 having two main parts 32 and 34. A shaft 42 extends from (or attaches to) the rear part 34 of the frame 32 and rearwardly extends upward at an angle for connection with handles or a handle section provided by two push bars 44. Grips 45d for operator hands may be received along the upper ends of push bars 44. As best shown in FIGS. 8B and 12A, bolts and nuts 43c may be used to attach shaft 42 to rear part 34 through holes 43a and 43b that extend through rear part 34 and shaft 42, respectively. To attach shaft 42 to push bars 44, bolts and nuts 45c may be used through holes 45a and 45b that extend through shaft 42 and lower end of push bars 44. The ON-OFF switch 124 is preferably mounted along shaft 42 near push bars 44, but may optionally be mounted to the back of plate 24. A switch holder 125 may be used to mount switch 124 to shaft 42, where screws or bolts 125a or other mechanism mounts the holder 125 to the top end of shaft 42 near the lower end of push bars 44. The tank 12 also has an attached boom assembly 36 for a nozzle 38 which sprays toward a surface, such as the ground 40. Thus, the tank 12 may be considered the center of an integrated assembly of the parts of the cart sprayer 10.

The frame section 32 is U-shaped in the center thereof so that it can be received and fit into recess 22 and effectively hangs the tank 12 on the frame 30. Two bolts or screws 59a on either side of tank 12 extend through holes 59b in frame section 32 into threaded holes 59c molded along tank 12. For purpose of illustration, one of such bolts 59a is shown in FIG. 1. Optionally, an additional bolt may be attached to the front of frame 30 to tank 12. Also, frame section 32 has legs 33 which bend forwardly and receive bearings 50, via openings 51, carrying a shaft 52 on which wheels 54 are journal mounted by providing axles 57 which rotate at each end of the shaft 52 upon bearings 50. Each wheel 54 has a hole extending through a central shaft 55a for mounting the wheel onto one of the two rotational axles 57. The end of each axle 57 has a hole 57b extending there through for receiving a cotter pin 55d after the wheel 54 is received on its axle 57 and extends through a washer 55e. This allows each wheel 54 to freely rotate upon its respective axle 57 (or to rotate with axle 57 upon bearings 50), while the cotter pins 55d retain the wheels 54 on axles 57. Less preferably where free rotation upon its axle is not desired, one or both wheels 54 may instead, or in addition to cotter pins 55d, be bolted (fixed) to its axle 57, such as using a bolt 55b extending through a hole 55c through central shaft 55a and a hole 57a in axle 57, to a tightened nut for fixing the wheel 54 onto the axle 57 so that wheel 54 and its associated axle 57 rotate together. Other mechanisms for mounting wheels 54 may also be used. The cart sprayer 10 assembly is therefore mounted on wheels 54 and can be pushed (or pulled) using push bars 44 along ground 40.

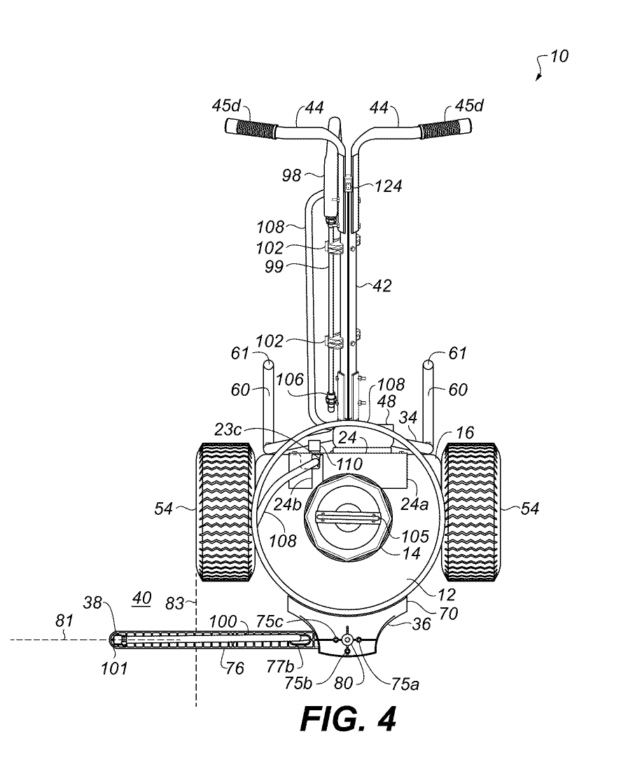

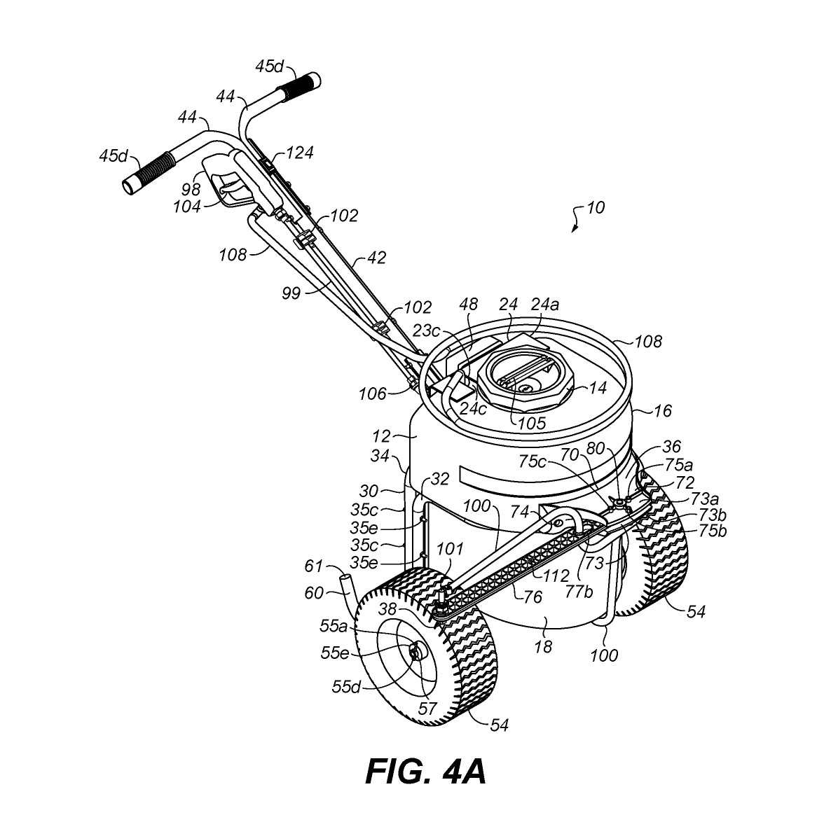

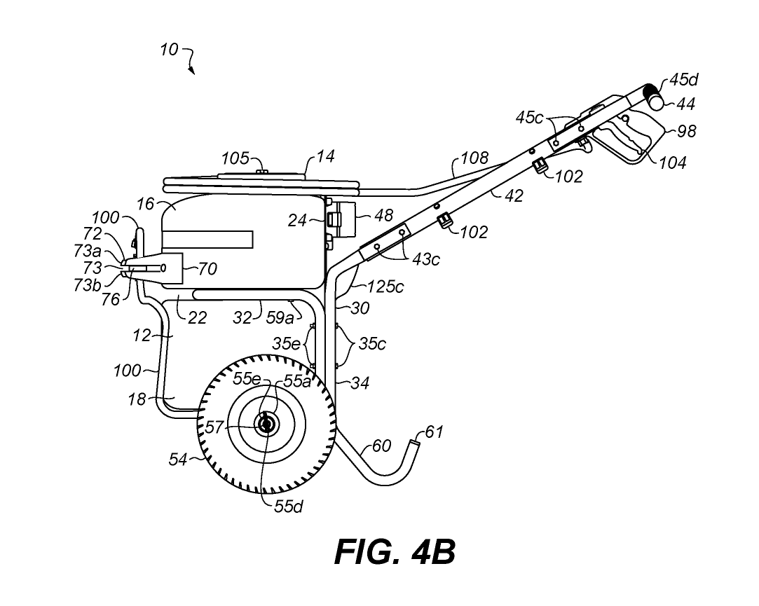

The rear section 34 of the frame 30 has legs which are connected to the legs of the front frame part 32 using bolts 35c, via holes 35a and 35b, along sections 32 and 34, respectively, to nuts 35e (FIGS. 4A, 4B, 5 and 8B). Each bolt 35c extends through a plastic spacer or washer 35d located between sections 32 and 34 when so joined together. The ends 60 of the legs of the rear frame section 34 form feet on which the cart sprayer 10 can be rested on the ground 40 (see FIG. 1). Rubber or plastic caps 61 may be received in ends 60 (FIGS. 1 and 8B).

Optionally, cart sprayer 10 may be pulled with an optional “T” shaped towing knuckle 58 as shown in dash lines in FIGS. 1 and 8A. The two opposing ends of the lateral leg 58a of knuckle 58 may be attached across the back of frame 30, such as using bolts 35c, which attach frame sections 32 and 34 together, via holes provided at such opposing ends. When cart sprayer 10 is towed by coupling to leg 58b, shaft 42 may be removed at its bolts 43c if needed from the rest of frame 30, and ON-OFF switch 124 relocated for placement on the outside of panel 24, and wand 98 maintained in the vehicle which is towing the cart sprayer 10. Coupling to the vehicle by knuckle 48 (or other attachment mechanism) may be in a manner similar to typical towed agricultural equipment, and thus details with respect to such coupling are not described herein.

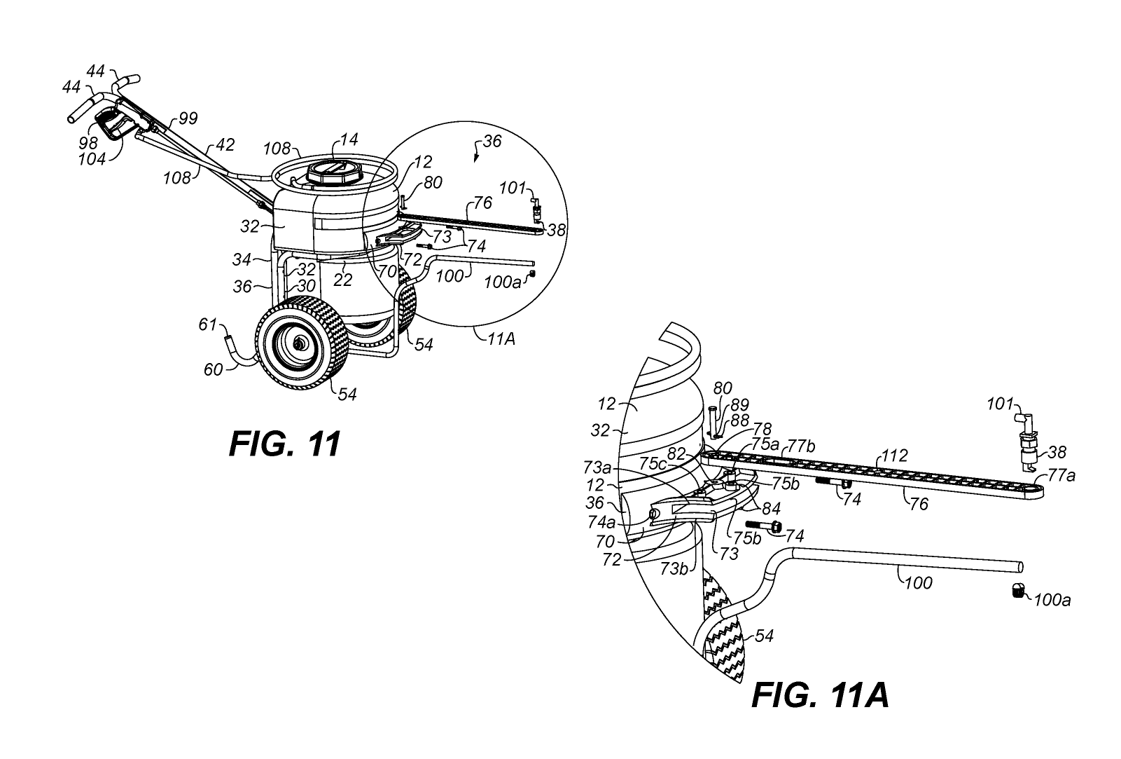

Boom assembly 36 has a curved back plate 70 and a slotted bracket 72 from which extends a boom arm 76. The assembly is best shown in the exploded view of FIG. 11, which is shown in more detail in FIG. 11A. Bracket 72 and back plate 70 may be a molded part or may be assembled together and attached to tank 12 with fasteners, such as bolts or screws 74, via holes 74a in back plate 70, into threaded holes 74b (FIG. 8A) molded along the curved front of the upper tank section 16. Boom arm 76 is preferably a metal (e.g., aluminum) bar with openings or spaces along its length for lightening its weight. For purposes of illustration, boom arm 76 is shown positioned above bracket 72 in FIGS. 11 and 11A. The rear end of arm 76 is received in a slot 73 of bracket 72. Bracket 72 has upper and lower walls 73a and 73b, respectively, defining slot 73. A hole 78 in the rear or proximate end of the arm 76 is rotationally captured by a pin 80 which passes through a central hole 82 of bracket 72, where such hole 82 passes through both walls 73a and 73b through the middle of the bracket 72. Thus, an upper part of hole 82 extends through the middle of a cross member 84 along the top of bracket 72, and lower part of hole 82 extends through the middle of an identical mirror cross-member 84 along the bottom of bracket 72. Pin 80 passes though both hole 82, via slot 73 and opening 78 of arm 76, and is then captured by a cotter pin 88 via a hole 89 through the bottom end of pin 80 (see FIG. 12B).

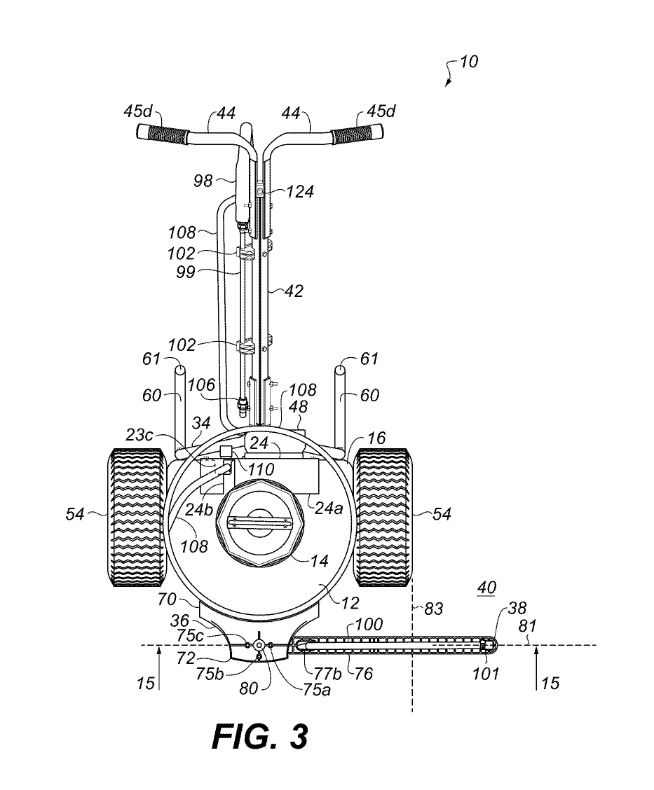

The slot 73 in bracket 72 permits pivotal movement of the boom arm 76 about pin 80 in hole 82, such as denoted by arrows 79 (FIG. 2), over an arc at or slightly more than 180 degrees so that the boom arm 76 can be positioned at any of the selected positions 90 degrees apart at the sides and the front of the sprayer 10, as shown best in FIGS. 2, 3 and 4. Thus, pin 80 provides a pivot member for rotating boom arm 76 in bracket 72. In other words, boom arm 76 position shown in FIG. 2 is aligned to the front of the sprayer, such as useful for towing of the cart sprayer 10, and boom arm 76 position in FIGS. 3 and 4 are for right and left side spraying, respectively, as useful for manual pushing of cart sprayer 10. The three positions of boom arm 76 are 90 degrees apart from each other. The side positions of boom arm 76 in FIGS. 3 and 4 are 180° apart from each other and perpendicular to the path of travel of the sprayer 10.

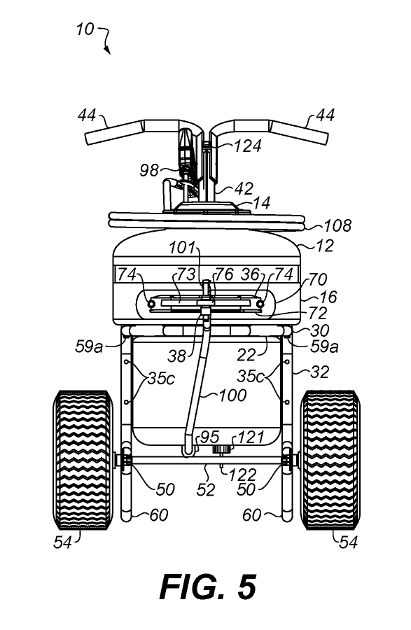

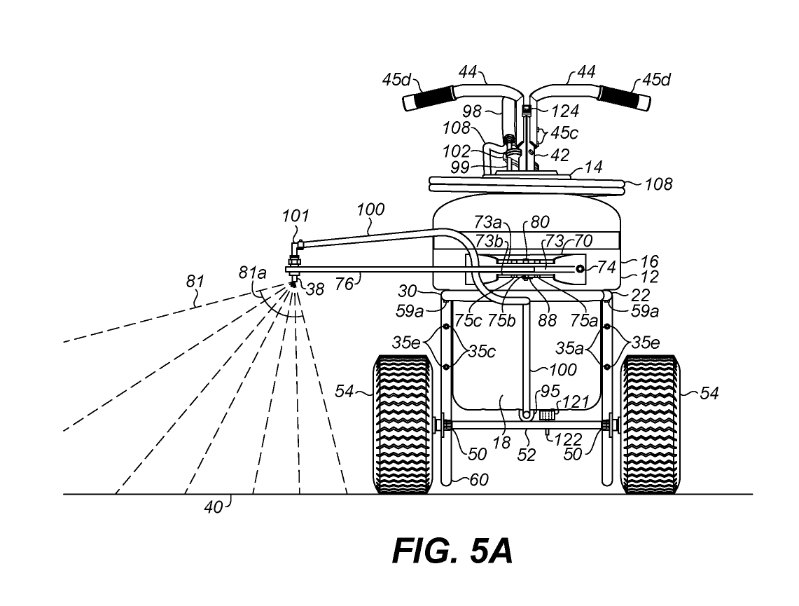

The front or distal end of the boom arm 76 has an opening 77a (FIG. 11A) for receiving the spray nozzle 38. Preferably, the nozzle 38 has an orifice through which the spray liquid passes out of the nozzle in a pattern providing a flat fan shape denoted by a spray 81 toward ground 40 in FIGS. 3 and 4. Spray 81 in FIGS. 3 and 4 is along a dimension aligned with the length of boom arm 76. For purposes of illustration, spray 81 is depicted in the figures when cart sprayer 10 is not in motion forwards or backwards along wheels 54. Preferably, spray 81 is in a wide angle 81a (see FIG. 5A), such as 90 degrees, along a distance on ground 40 extending under the boom arm 76 approximately 2 inches away from a virtual line 83 (FIGS. 3 and 4) perpendicular to spray 81 and aligned with the outer edge of the closest wheel 54, to approximately 3 to 4 feet away from the nozzle 38. However, other range of the spray 81 may be used by providing different nozzles or tips along the outlet end of nozzle 38. While FIG. 5A shows spray 81 along angle 81a for left side spraying, spray 81 may similarly be provided along a mirrored one of angle 81a of FIG. 5A along the right side of sprayer of FIG. 3 for right side spraying. Thus, a spray pattern is provided which is principally to the either right side (FIG. 3) or left side (FIG. 4) of the sprayer 10 as desired by operator selected boom arm position, which is directed away from the path of travel of the cart sprayer 10 to ensure no passage or trampling over any fresh spray on the ground as the sprayer 10 travels along its path. Although the fan spray 81 is shown as being along the length of boom arm 76 (FIGS. 3 and 4), the direction of the fan spray 81 may set at an orientation approximately perpendicular, or non-perpendicular, so that spray is directed towards the ground 40 as desired. Optionally, nozzle 38 may be rotationally mounted to boom arm 76 so that it can be manually rotated in position to obtain the desired fan spray 81 along ground 40 with respect to sprayer 10. Less preferably, when boom arm 76 is positioned as shown in FIG. 2 in front of cart sprayer 10 and boom arm 76 is aligned with the path of travel of the cart sprayer 10, the nozzle 38 or the tip along the outlet end of such nozzle is replaced with a flood or fan spray 81b perpendicular to the length of boom arm 76. If nozzle 38 is rotationally mounted to boom arm 76, it may be rotated to a position to obtain such spray orientation of FIG. 2.

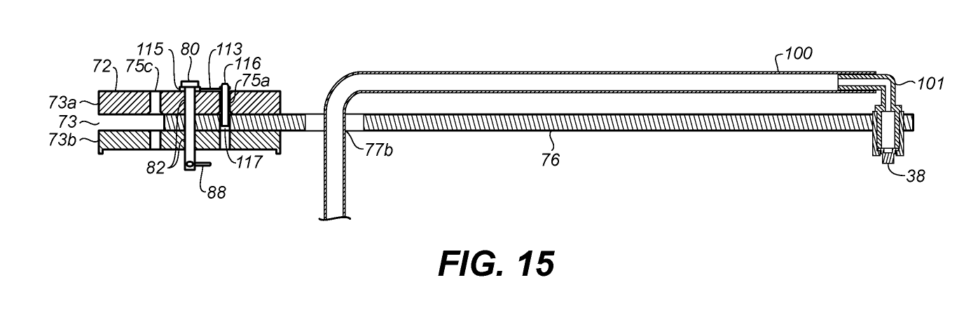

Boom arm 76 is slidable along the interior of upper and lower walls 73a and 73b, respectively, of slot 73 of bracket 72 about its pivotal range of motion by rotation along an axis of rotation extending through the center of the pin 80 and hole 78. The boom arm 76 has a mechanism for releasably locking the arm at each of its pivot positions depicted in FIGS. 2, 3, and 4, which is provided by either a detent mechanism of FIGS. 12A and 12B, or a pin mechanism of FIGS. 14 and 15. For purposes of illustration, the mechanism for releasably locking boom arm 76 is not shown in the exploded views of FIGS. 8A and 8B.

As shown in the cross-sectional views of FIGS. 12A and 12B, the detent mechanism has a spring plunger 76a mounted in a hole 76b of boom arm 76 so that a ball (pin or member) 76c of the spring plunger 76a under bias of its internal spring 76d can be captured in each one of three holes 75a, 75b, and 75c at 0, 90, and 180 degrees, respectively, as the boom arm 76 with its plunger 76a moves along an arc about its axis of rotation to temporarily fix boom arm 76 at right, center, and left positions shown in FIGS. 3, 2, and 4, respectively. Holes 75a, 75b, and 75c (also referred to herein as 75a-c) each extend through lower wall 73b of slot 73 and are spaced at locations so that holes 75a-c provide openings along the lower wall 73b of slot 73 so that ball 76c can slide along the lower wall 73b into and between holes 75a-c when boom arm 76 is moved manually by the operator. In this manner, a detent mechanism is provided that temporarily keeps the boom arm 76 in a desired pivot position relative to tank 12 where the boom arm can be released by applying a rotational force (or torque) to the boom arm. Holes 75a, 75b and 75c may extend through upper and lower slot walls 73a and 73b, however their placement in upper slot wall 73a is optional where the detent mechanism described herein is used.

Holes 75a, 75b, and 75c along lower slot wall 73b are preferably of a diameter to capture ball 76c, but with applied manual torque to boom arm 76 allows the ball 76c to slide backwards against bias of spring 76b when slid against the upper edge of each hole 75a-c up onto lower wall 73b to release the ball from such hole when desired. In other words, to select a different boom arm 76 pivot position, manual pressure along the arm 76 can pivot it towards a different position by pushing ball 76c of the spring plunger 76a backwards and away from one of holes 75a-c, sliding ball 76c along lower wall 73a of slot 73, and letting the ball 76 under bias of spring 76d move forward into a different one of holes 75a-c along slot 73. Additional releasable locking positions for boom arm 76 may similarly be provided by providing additional one(s) of holes 75a-c at other degrees with same or different nozzle 38 or outlet tip as desired. Optionally holes 75a-c may be provided by recesses along upper wall 73a which can similarly releasably capture ball 76c of spring member 76a if positioned with respect to such holes in the same manner as along lower wall 73b. Other mechanisms for releasably locking the boom arm 76 at a selected pivot position may be used, such as described later below in connection with FIGS. 14 and 15.

The sprayer 10 uses several flexible hoses which extend from two outlets 109 of the two-way valve 28, where one of such outlets 109 is shown in FIG. 7, and both are shown in FIG. 8B. The lower one of outlets 109 is in fluid communication via a hose 100 to nozzle 38 in the boom arm 76, and the upper one of outlets 109 is in fluid communication via a hose 108 with a sprayer wand (or gun) 98 having a nozzle 106. Spray wand 98 is described hereinafter in greater detail. As shown in FIG. 1, hose 100 extends via an opening 77b in boom arm 76 along the top of the arm to a coupler 100a, which connects the hose to a right angle input port 101 of nozzle 38.

Sprayer wand 98 has a spray shut-off with a trigger 104 in its handle portion to allow pressurized liquid to flow through the wand's tubular shaft or extension 99 to a spray nozzle 106 when trigger is depressed by the operator holding the wand. Nozzle 106 provides a spray head at the distal end of shaft 99 of sprayer wand 98. The shut-off may refer to a valve in the handle portion which operates responsive to trigger 104 to control liquid flow down tubular shaft 99 to distal nozzle 106, as typical of sprayer wands. An example of sprayer wand 98 with such a shut-off is shown in U.S. Pat. No. 8,939,387, issued Jan. 27, 2015, which is incorporated herein by reference, in which an optional distal nozzle upon a tubular extension is utilized with or without the additional valve and supporting structure provided therein. Other sprayer wands or spray guns than that shown in the figures may receive liquid from hose 108, such as those used with backpack sprayers manufactured by Chapin Manufacturing, Inc. of Batavia, N.Y.

Spring snap in holders 102 attach along shaft 42 to releasably hold spray wand 98 along its shaft 99 when not in use. The spray wand 98 may alternatively be releasably held by its shaft 99 being received into an optional slot 105 through a raised portion 35 of cap 14, as desired by the operator. Bolts 103a and nuts 103b may be used to attach holders 102 through holes along shaft 42 (FIG. 8B). The nozzle 106 may have a spray orifice of circular cross-section to produce a generally conical spray, as typical of a spray gun, but a nozzle may be provided with a spray orifice providing other cross-section spray shapes as desired. Hose 108 may be coiled along the top of top tank section 16 around the cap 14 of the tank 12. Hose 108 connects via a coupling on the two-way valve 28 along the front or inside surface of plate 24 (see FIGS. 4 and 7). The tank 10 is shaped to provide a channel (or groove) 23c for passage of the hose 108 end coupled to valve 28 via slot 24b in top L-shaped part 24a of plate 24. By selection of two-way valve 28 position, pump 26 supplies spray liquid to either nozzle 38 in the boom arm 76, or to sprayer wand 98, as described below.

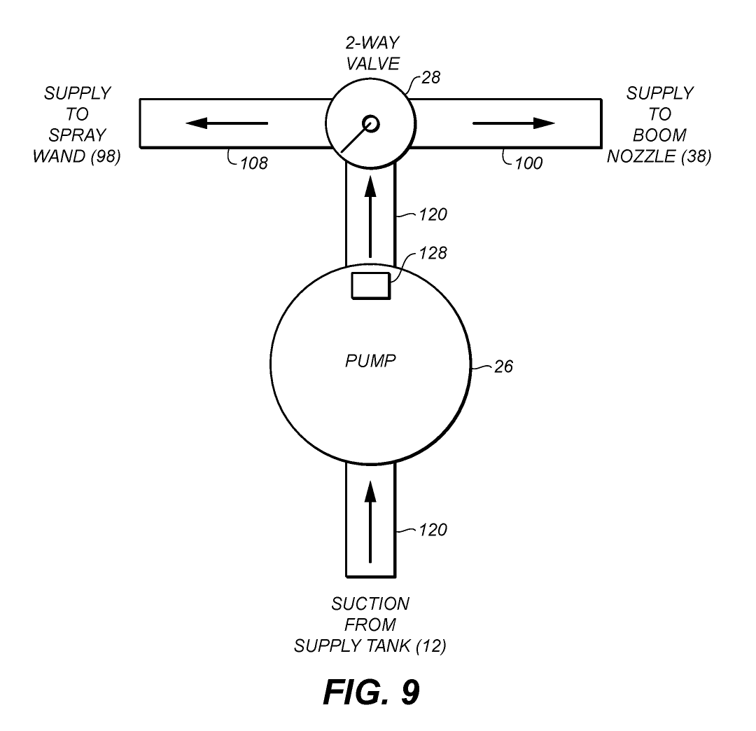

Referring to FIG. 6A, a handle or lever 110 of two-way valve 28 is mounted on the back, outside, or exposed side or surface of the plate 24 via an opening in the plate. Handle 110 provides a selector for operating the two-way valve to its two positions. With the handle 110 in the vertical or up position as shown in FIG. 6A, the two-way valve 28 connects the pump 26 to the nozzle 38 at the front end of the boom arm 76, via hose 100 and coupler 100a. With the handle 110 in its alternative position turned 90 degrees to horizontal (i.e., handle 110 turned to the right in FIG. 6A), the two-way valve 28 connects the pump 26 to the sprayer wand 98 via hose 108, so that when trigger 104 is depressed, liquid provided via hose 108 can pass through nozzle 106, as typical of a spray gun. Thus, hydraulic communication of liquid to either a first path to sprayer wand 98 or a second path to the boom nozzle 38 can be selected for spraying by turning handle 110 of the two-way valve 28 as desired, while hydraulic communication ceases along the unselected path. When sprayer wand 98 is selected, hose 108 may be uncoiled to enable the wand to be carried over to wherever spraying with the wand 98 is to be carried out. Supply liquid provided to two-way valve 28 is inputted to pump 26 from the tank 12 through another hose 118 (see FIG. 7). A hydraulic schematic of fluid flow in sprayer 10 using liquid pumped by pump 26 from tank 12 is shown in FIG. 9 to illustrate hydraulic fluid communication of the above described components.

As shown in FIG. 7, hose clamps 27 are provided along panel 24 for connecting hoses 100 and 108 to the two-way valve 28 outlets 109, hose 29 from pump 26 outlet or output 26a to valve 28 inlet 111, and hose 118 to pump 26 inlet 26b. Coupler 118a connects lower end of hose 118 to tank 12 outlet port 119 using hose clamp 118b (see FIG. 7), so that pump 26 inlet is in fluid communication with tank 12 liquid. The preferred connection of hose 118 to tank 12 is shown in FIGS. 6A, 7A, and 7B. Hoses 100, 108, 29, and 118 represent conduits for communication of liquid. Hose 100 is flexible and movable in boom arm opening 77b to allow freedom to pivot boom arm 76 as described herein, and hose 108 is flexible to allow freedom of movement of wand 98 by a user when removed from holders 102 to shaft 42 or slot 105.

Referring to FIGS. 6A, 7A, and 7B, tank outlet port 119 is preferably provided by a T-shaped conduit as best shown in FIG. 7B having a horizontal conduit 119a into tank 12 at or near the base of the tank 12 as shown in FIG. 7B (see arrow indicating direction of fluid flow when drawn by pump 26), a vertical downward extending externally threaded opening 120 which provides a drain for tank liquid when present, and a barbed opening 119b opposite opening 120 onto which the lower end of hose 118 is received. When the drain is not is use, it is closed by an internally threaded cap 121 over opening 120. Cap 121 may be retained by a tether 122 coupling the cap to a ring 123 about the base of opening 120. This allows liquid flow when drawn by pump 26 into conduit 119a and up vertical opening 119b via hose 118. For purposes of illustration, such preferred T-shaped conduit providing outlet port 119 is not shown in FIGS. 8A and 8B.

Recess 23b along the tank 12 below recess 23a is provided for hoses 100 and 118 under the bottom of panel 24, as shown in FIGS. 6A and 8B. After extending downwards along recess 23b, hose 100 then extends under the bottom of the tank 12 (FIG. 6B) to the front of the tank for connection to nozzle 38 (FIG. 4A). Preferably hose 100 extends through an aperture of a ring (or loop) 95 that extends downward from the bottom of tank 12 for supporting and positioning hose 100. Recesses 23a and 23b, and channel 23c may be formed when tank 12 is molded, along with optional support ring 95. Screws 31a (FIG. 8B) may be provided for mounting components to panel 24 via holes provided along such panel (nuts may optionally be used with such screws), such components include mounting pump 26 via holes 31b into four threaded holes along panel 24, and for similarly mounting valve 28 and battery shoe or receptacle 46 to panel 24. Panel 24 is shown in FIG. 6A with a preferred position of the panel 24 with respect to tank 12, and preferred position of the battery 48 on the panel. However, the battery 48 may be positioned differently on the panel in its receptacle 46 than shown in FIG. 6A to enable external access by a user.

The pump 26 may be a diaphragm pump having a flexible diaphragm and a pair of check (one-way) valves. One of the check valves is associated with the inlet to the pump and the other check valve is associated with the outlet of the pump. The diaphragm is flexed cylindrically by a cam mechanism, which may be an elliptically shaped disc rotated by the electric motor of the pump unit. When flexed in one direction, the diaphragm is on the suction part of its cycle and liquid is sucked into the pump because the check valve connected to its outlet is closed and the check valve associated with the pump inlet is open to allow liquid flow to the pump. Conversely when the diaphragm is flexed in the other direction on the pressure part of the cycle, the check valve connected to the outlet is opened and the check valve connected to the inlet is closed, thereby providing pressurized liquid through the outlet to the two-way valve 28 for spraying either by the nozzle 38 on the boom arm 76 or the nozzle 106 on the end of the sprayer wand 98 as selected by handle 110.

Referring to FIG. 10, an electrical schematic is shown having battery 48 connected via ON-OFF switch 124. Panel 24 facilitates access to other components of the electric circuit shown in FIG. 10. Wires 125c connect by tabs or connectors 125b at ON-OFF switch 124 (see FIG. 8B). Such wires 125c extend from ON-OFF switch 124 to the circuit along panel 24 via shaft 42 (see FIGS. 6A and 6B). To turn ON the motor of the pump 26, the ON-OFF switch 124 is placed in its ON position. Current powering the pump 26 flows through a low voltage cut-off circuit 126, and a pressure switch 128, on the output side of the pump (see FIG. 7), to the pump 26 motor and then back to battery 48. The low voltage cut-out circuit 126 senses the voltage across the battery 48. The low voltage cut-off circuit 126 has a switch which opens the circuit connected to pump 26 motor to cease operation of pump 26 motor (and spraying if occurring via nozzle 38 or 106) since low voltage condition provides insufficient power for effective pumping and spraying. Optionally, the low voltage cut-off circuit 126 may have a warning light, such as a red LED lamp, mounted on the rear of panel 24 which indicates the low voltage condition. The pressure switch 128 is part of the pump 128, as shown in FIG. 9, it senses the pump output pressure so that current is allowed to flow to pump 26 when at or below a psi threshold level, and when such threshold psi level is exceeded disables current to pump 26, as typical of a pressure switch on demand pumps. For example, such threshold level is 50psi. Pressure switch is useful when sprayer wand 98 is selected by the operator via handle 110 for spraying liquid from tank 12, so as to avoid excessive pressure build up in the pump when not spraying via its nozzle 106.

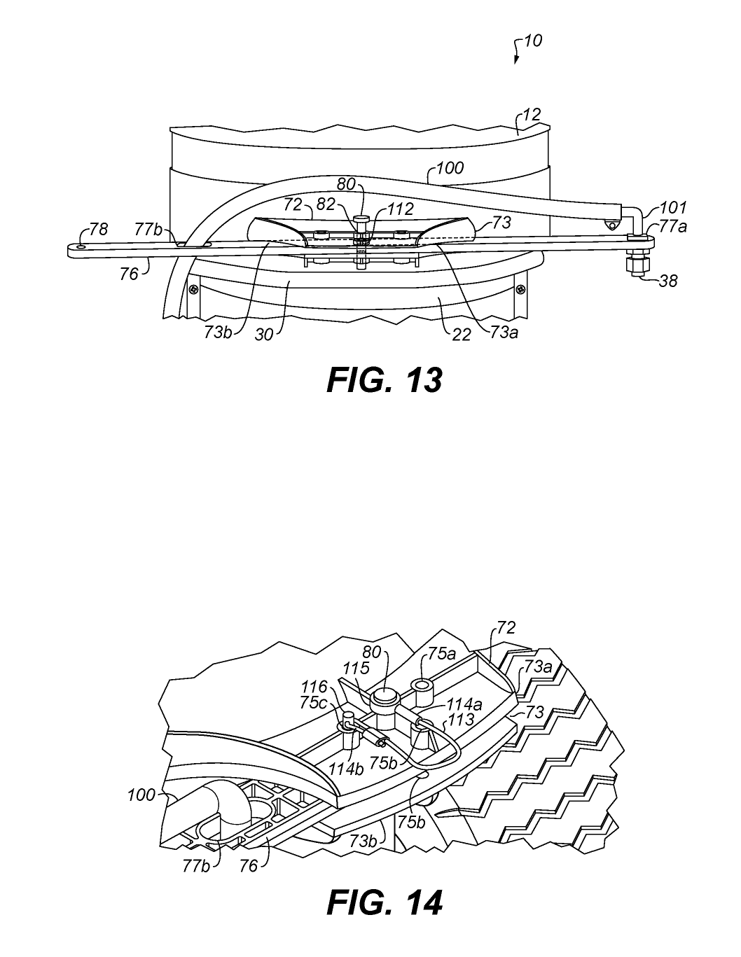

When sprayer 10 is not being used, the boom arm 76 may be moved to a storage/transport position in bracket 72 as shown in FIG. 13 using a hole 112 (FIGS. 1 and 4A) provided at (or approximately) the middle of boom arm 76. To move boom arm 76, pin 80 is removed from bracket 72 of boom mechanism 36 by removing cotter pin 88 (FIG. 12B) from hole 89 of pin 80, and then manually lifting pin 80 upwards from central hole 82 of bracket 72. Boom arm 76 is positioned in slot 73 of bracket 72 so that hole 112 of the boom arm is aligned with central hole 82, and then placing pin 80 in hole 82, via hole 112, so that pin 80 again extends in hole 82 through bracket 72 via slot 73. If desired, cotter pin 88 is placed back in hole 89 of the pin 80 to retain the boom arm 76 to bracket 72 in its mid position shown in FIG. 13. This minimizes (or avoids) rotational motion of boom arm 76 in bracket 22, and reduces the extent boom arm 76 extends outward along right and left sides of sprayer 10 to one-half (or approximately one-half) of the extent boom arm 76 normally extends from tank 12 as shown in other figures, thereby reducing risk of damage to boom arm 76 (as well as nozzle 38) when sprayer 10 is stored or transported. Also, use of pin 80 in bracket 72 further enables boom arm 76 to be removable from sprayer 10 if needed for replacement. Boom arm 76 is shown as a solid member in FIG. 13 with openings 77a, 77b, 78, and 112 described earlier, preferably boom arm 76 has other openings (or grid structure) along its length for lightening its weight as shown in other figures.

Optionally, and preferably, a pin mechanism for retaining the boom arm 76 position as shown in FIGS. 14 and 15 is used instead of the detent mechanism for releasably locking boom arm 76 described earlier in connection with FIGS. 12A and 12B. In such preferred mechanism for releasably locking pivotal movement of boom arm 76 in bracket 72, a pin (or retainer member) 116 extends into slot 73 of bracket 72 via one of holes 75a, 75b and 75c of upper wall 73a of bracket 72 into an opening (or hole) 117 (FIG. 15) of boom arm 76 provided along arm's grid structure (previously occupied by spring plunger 76—FIG. 12B) to retain the boom arm pivot position when pivoted at right, center, and left positions, respectively. The pin 116 is shown as extending partially in slot 73 to engage boom arm 76 via opening 117, but may be of a length such that pin 116 extends through slot 73 partially into or through such one of holes 75a, 75b, or 75c in the lower wall 73b of bracket 72 associated with desired boom arm pivot position. While boom arm 76 in the example of FIG. 14 is shown locked by pin 116 via hole 75c of bracket 72 for spraying along the left side of travel of sprayer 10, pin 116 may be removed from hole 75c and similarly used in hole 75a or 75b with boom arm 76 aligned for receiving such pin 116 via opening 117 of boom arm 76. Pin 116 is shown received in hole 75a in FIG. 15. To move the boom arm 76 to a different pivot position, pin 116 is manually lifted and removed from boom arm 76 and bracket 72 from its original one of holes 75a-c of upper wall 73a (and optionally lower wall 73b) of bracket 72, boom arm 76 is pivoted (rotated) about pin 80 so that opening 117 of the boom arm 76 is aligned in slot 73 with a different one of holes 75a-c, and then pin 116 is received in such different one of holes 75a-c and opening 117 to lock the boom arm 76 at its new pivot position. Thus, each of three holes 75a, 75b, and 75c at 0, 90, and 180 degrees, respectively, can be used with pin 116 as the boom arm 76 moves along an arc about its axis of rotation set by pin 80 to temporarily lock boom arm 76 at right, center, and left positions shown in FIGS. 3, 2, and 4, respectively. Additional or different ones of such holes may be provided along this arc in bracket 72 at other degrees than those associated with holes 75a-c, if desired, at which boom arm 76 may pivot to and be releasably locked by pin 116 via opening 117 of the boom arm.

Pin 116 of the releasably boom locking mechanism may be coupled to a lanyard or tether 113 (e.g., such as a flexible cable, wire, or cord) to sprayer 10. For example, tether 113 has two ends 114a and 114b. End 114a is attached to coupler/boss 115 extending about upper end of hole 82, and the other end 114b passes through a hole at the top end of pin 116. Although such tethering mechanism is shown, other mechanisms for tethering pin 116 may be used. Also, as in the case of pin 80, pin 116 may have a head that is larger in diameter than holes 75a-c, so as to dispose pin 116 in holes 75a-c as desired with or without tether 113. As best shown in FIG. 15, the diameter of holes 75a-c and opening 117 of the boom arm 75 are the same (or approximately the same), and pin 116 is of a diameter slightly smaller than holes 75a-c and opening 117. Bracket holes 75a-c for receiving pin 116 are co-axial with each other as well as with hole 82 for pin 80.

There has been described a cart sprayer having improved mechanical and electrical design features which provide the sprayer with better performance than such sprayers heretofore proposed or available on the market. Variations and modifications of the herein described cart sprayer within the scope of the invention will undoubtedly suggest themselves to those skilled in the art. For example, the components mounted on panel 24 may be disposed differently than shown in the figures so long as pump 26 and valve 28 are disposed to enable fluid communication as described herein via hoses 109, 100, and 118 as desired by selection of handle 110 position during operation of sprayer 10. Accordingly, the foregoing description should be taken as illustrative, and not in a limiting sense.

1. A cart sprayer which travels over the ground along a path which comprises:
an assembly of a wheel mounted frame assembled with a tank fillable with liquid to be sprayed;
an electrohydraulic assembly having a battery operated pump in hydraulic communication with said tank for pumping liquid from said tank to a nozzle which directs a spray of said liquid toward the ground, said nozzle being mounted to said assembly on a mounting having a pivotal arm extending outwardly away from said assembly for locating said nozzle at a position to a side of said path away from the path of travel of said cart sprayer, whereby to prevent interaction between sprayed ground with the cart sprayer and its operator.

2. The cart sprayer according to claim 1 wherein said mounting for said arm is attached to said tank of said assembly.

3. The cart sprayer according to claim 1 wherein said mounting provides a rotational support for said arm at an end of said arm opposite to an end thereof carrying said nozzle, and a mechanism engaging said arm to maintain said arm at said position.

4. The cart sprayer according to claim 3 wherein said mechanism has one of detents for engaging a spring biased member from said arm when pivoted to said position.

5. The cart sprayer according to claim 3 wherein said mechanism has an opening along said arm for receiving a retainer member extending via one of a plurality of holes in said mounting each said plurality of holes being associated with a different pivot position of said arm.

6. The cart sprayer according to claim 3 wherein said position is one of a plurality of positions comprises a second position away from an opposite side of said path.

7. The cart sprayer according to claim 6 wherein said second position is about 180° from said one position along the path of rotation of the arm.

8. The cart sprayer according to claim 6 wherein said plurality of positions further comprises a third position in a direction along said path to enable spraying along said path.

9. The cart sprayer according to claim 1 wherein said pump is a demand pump having an electric motor powered by said battery via an electric circuit, said circuit having a switch operated by the output pressure of said pump for breaking the circuit between said battery and said pump when said output pressure exceeds a certain limit corresponding to absence of demand for spraying liquid.

10. The cart sprayer according to claim 9 wherein said circuit includes an on/off switch which is switchable off for cutting off power to said pump for stopping pumping for spraying via said nozzle.

11. The cart sprayer according to claim 10 further comprising a portable wand spray head having a shut-off, said hydraulic communication to said nozzle being via a two-way valve selectively providing communication to said nozzle on said arm or to said wand spray head whereby, when said on-off switch closes said circuit and said two-way valve selects said wand spray head and said output pressure increases to said limit when said switch stops wand spraying automatically by cutting off power to said pump with said switch.

12. The cart sprayer according to claim 1 wherein said assembly further comprises a plate on which said battery is mounted on an outside thereof and said pump is mounted on an inside thereof, said plate being attached to said tank with said inside against said tank.

13. The cart sprayer according to claim 1 wherein said tank has a recess between an upper and a lower portion of said tank, said recess having a generally circular shape facing forwardly of said tank, and said frame having a section which is generally circular which is received in said recess, said frame section also having legs below said frame, a shaft carrying wheels, on which said cart is moveably connected between said legs.

14. The cart sprayer according to claim 1 further comprising a handle for pushing said cart sprayer from behind said sprayer, said handle being connected to a member which connects to said frame on a rear side thereof, said handle enables the operator to lift and push said assembly of tank and frame along said path.

15. The cart sprayer according to claim 1 wherein said nozzle is a first nozzle, and said cart sprayer further comprises a wand having a second nozzle, said hydraulic communication being via a two-way valve selectively providing communication to one of said first nozzle and said second nozzle, and a selector coupled to said two-way valve movable to select one of said first nozzle and said second nozzle for spraying.

16. A cart sprayer comprising:
a tank mounted on a frame having wheels; and
an arm rotationally mounted along a front of said tank for pivoting about an axis of rotation to a plurality of different positions, wherein said arm has a distal end with a spray nozzle which extends away from said tank for spraying liquid pumped from said tank.

17. The cart sprayer according to claim 16 further comprising means for releasably locking a proximal end of said arm at along said axis of rotation to select one of said plurality of different positions.

18. The cart sprayer according to claim 16 further comprising a battery operated pump providing liquid from said tank via at least one conduit to said nozzle.

19. The cart sprayer according to claim 18 wherein said nozzle represents a first nozzle, and said conduit represents a first conduit, and said cart sprayer further comprises a wand having a second nozzle from receiving pumped fluid via a second conduit, and a two-way valve for selecting one said first nozzle for receiving liquid from said pump via said first conduit, and said second nozzle for receiving liquid from said pump via said second conduit.

20. The cart sprayer according to claim 16 wherein said arm extends along a length from said sprayer to enable said nozzle to spray outside of a path of travel of said wheels when said arm is pivoted to one of said plurality of different positions along a left or right side of said sprayer.

21. The cart sprayer according to claim 20 wherein sprayed liquid from said nozzle has a fan shape pattern aligned along said length of said arm.

22. The cart sprayer according to claim 16 wherein said arm is pivoted to one of said plurality of different positions in front of said tank to enable said nozzle to spray along of a path of travel of said wheels.

23. The cart sprayer according to claim 16 further comprising a bracket having a slot mounted along the front of said tank, a pivot member extending through a central hole of said bracket via said slot, and said arm having a proximal end with an opening through which said pivot member extend to rotational mount said arm for motion along said slot about said pivot member to thereby rotationally mount said arm along said front of said tank, in which said pivot member defines the axis of rotation for said arm along said slot of said bracket.

24. The cart sprayer according to claim 23 further comprising a plurality of holes in said bracket that extend into said slot, wherein each of said plurality of holes is associated with a different one of said plurality of different positions of said arm, and a removable retainer member received in one of said plurality of holes to engage said boom arm and lock the boom arm from pivoting when said boom arm is pivoted to one of said plurality of different positions associated with said one of said plurality of holes.

25. The cart sprayer according to claim 23 wherein said opening is a first opening, and said arm has a second opening at least approximately centered about a length of said arm, and said pivot member is repositionable to extend through said second opening of said arm through said central hole via said slot of said bracket to minimize rotational motion of said arm along said slot and to reduce the extent said arm extends distally from said sprayer, thereby minimizing risk of damage to said arm during storage or transportation of said sprayer.

26. A method for spraying liquid from a cart sprayer comprising the steps of:
mounting an arm for pivoting about an axis of rotation along a front of a cart sprayer;
providing a spray nozzle at the distal end of said arm for receiving liquid from a tank; and
releasably locking a proximal end of said arm at a plurality of different positions along said axis of rotation to select different locations for spraying the liquid from said nozzle as said sprayer is manually pushed on wheels along a surface.
